(19) United States
(12) Patent Application Publication
(10) Pub. No.: US 2017/0118402 A1
(43) Pub. Date: Apr. 27, 2017

(54) ELECTRONIC DEVICE AND CAMERA CONTROL METHOD THEREFOR

(71) Applicant: Samsung Electronics Co., Ltd, Gyeonggi-do (KR)

(72) Inventors: IL Geun Bok, Seoul (KR); Bong Gun Kim, Gyeonggi-do (KR); Jung Hee Yeo, Seoul (KR); Ha Youl Jung, Gyeonggi-do (KR)

(21) Appl. No.: 15/331,807

(22) Filed: Oct. 21, 2016

(30) Foreign Application Priority Data
Oct. 22, 2015 (KR) 10-2015-0147112

(51) Int. Cl. H04N 5/232; H04N 5/247; G06F 3/0488

(52) U.S. Cl. CPC H04N 5/23216; G06F 3/04883; H04N 5/247; H04N 5/23293

(57) ABSTRACT

An electronic device includes a display configured to include a front region, a side region connected with an edge of the front region, and a rear region connected with an edge of the side region. The electronic device also includes a touch sensor configured to sense a touch input on the front region, the side region, or the rear region, a camera module configured to generate an image for an object to be captured, and a processor configured to electrically connect with the display, the touch sensor, and the camera module. The processor is configured to activate the camera module when a plurality of touch inputs on designated locations are detected by the touch sensor, to detect an additional input after at least one of the plurality of touch inputs is changed, and to execute a function mapped with an input pattern of the additional input.

### CROSS-REFERENCE TO RELATED APPLICATION(S) AND CLAIM OF PRIORITY

The present application is related to and claims the benefit under 35 U.S.C. §119(a) of a Korean patent application filed on Oct. 22, 2015 in the Korean Intellectual Property Office and assigned Serial number 10-2015-0147112, the entire disclosure of which is hereby incorporated by reference.

### TECHNICAL FIELD

The present disclosure relates to technologies for controlling a camera module of an electronic device having a curved display.

### BACKGROUND

With the development of electronic technologies, various types of electronic devices have been developed and distributed. Particularly, recently, electronic devices, such as smartphones and tablet personal computers (PCs), which perform various functions, have come into wide use. The above-mentioned electronic device usually includes a camera module which may capture images. Also, recently, there has been a growing interest in developing an electronic device having a curved display in the form of covering at least three surfaces (or four surfaces) of the electronic device.

The electronic device having the above-mentioned curved display may output an image on a front surface, a left side surface, and a right side surface (or the front surface, the left side surface, the right side surface, and a rear surface) of the display. If a touch sensor is installed in a display region of the curved display, a touch input may be provided to the front surface, the left side surface, and the right side surface (or the front surface, the left side surface, the right side surface, and the rear surface) of the display.

Research and development for the curved display which covers the electronic device have been actively conducted. However, there is the lack of interest in a user interface which uses the curved display. Also, a user interface in a conventional touch screen display may not use advantages of the curved display sufficiently, in which the curved display may output an image and receive a touch input on at least three surfaces of the display.

### SUMMARY

To address the above-discussed deficiencies, it is a primary object to provide an electronic device having a curved display which covers the electronic device for providing a user interface for controlling a camera module using a touch input on a side surface (or the side surface and a rear surface) of the display.

In accordance with an aspect of the present disclosure, an electronic device is provided. The electronic device may include a display configured to include a front region, a side region connected with an edge of the front region, and a rear region connected with an edge of the side region, a touch sensor configured to sense a touch input on the front region, the side region, or the rear region, a camera module configured to obtain an image for an object to be captured, and a processor configured to electrically connect with the display, the touch sensor, and the camera module. The processor may be configured to activate the camera module, if a plurality of touch inputs on designated locations are obtained by the touch sensor, to obtain an additional input, after at least one of the plurality of touch inputs is changed, and to execute a function mapped with an input pattern of the additional input.

In accordance with another aspect of the present disclosure, a method is provided. The method may include activating a camera module of an electronic device, if a plurality of touch inputs on designated locations of a display of the electronic device are obtained, obtaining an additional input, after at least one of the plurality of touch inputs is changed, and executing a function mapped with an input pattern of the additional input based on the input pattern of the additional input.

In accordance with another aspect of the present disclosure, a computer-readable recording medium storing instructions executed by at least one processor is provided. The instructions may be configured to activating a camera module of an electronic device, if a plurality of touch inputs on designated locations of a display of the electronic device are obtained, obtaining an additional input, after at least one of the plurality of touch inputs is changed, and executing a function mapped with an input pattern of the additional input based on the input pattern of the additional input.

Other aspects, advantages, and salient features of the disclosure will become apparent to those skilled in the art from the following detailed description, which, taken in conjunction with the annexed drawings, discloses various embodiments of the present disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIGS. 1A and 1B illustrate an environment where an electronic device operates according to an embodiment;

FIG. 2 illustrates a configuration of an electronic device according to an embodiment;

FIG. 3 illustrates an electronic device and a region where a touch input is received on a display of the electronic device according to an embodiment;

FIG. 4 illustrates an electronic device and a region where a touch input is received on a display of the electronic device according to an embodiment;

FIG. 5 illustrates an electronic device and a region where a touch input is received on a display of the electronic device according to an embodiment;

FIG. 6 illustrates an exemplary implementation in which an image is output on a display of an electronic device according to an embodiment;

FIG. 7 illustrates an electronic device and a region where a touch input is received on a display of the electronic device according to an embodiment;

FIG. 8 illustrates a flowchart of a camera control method of an electronic device according to an embodiment;

FIG. 9 illustrates a flowchart of a camera control method of an electronic device according to an embodiment;

FIG. 10 illustrates a configuration of an electronic device in a network environment according to various embodiments;

FIG. 11 illustrates a configuration of an electronic device according to various embodiments; and

FIG. 12 illustrates a configuration of a program module according to various embodiments.

Throughout the drawings, it should be noted that like reference numbers are used to depict the same or similar elements, features, and structures.

### DETAILED DESCRIPTION

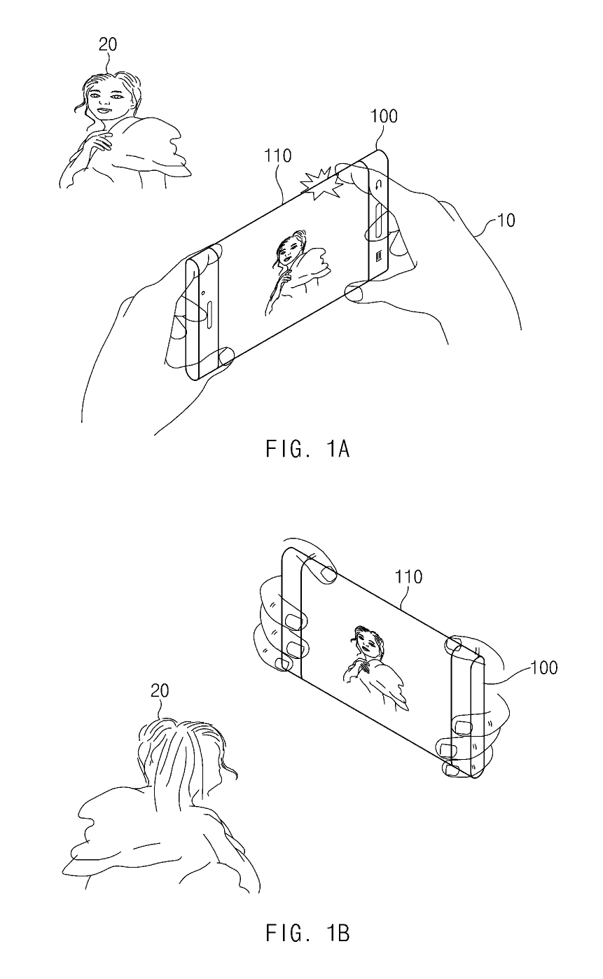

FIGS. 1A through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device.

Hereinafter, the present disclosure is described with reference to the accompanying drawings. However, the present disclosure is not intended to be limited to the specific embodiments, and it is understood that it should include all modifications and/or, equivalents and substitutes within the scope and technical range of the present disclosure. With respect to the descriptions of the drawings, like reference numerals refer to like elements.

In the disclosure disclosed herein, the expressions “have”, “may have”, “include” and “comprise”, or “may include” and “may comprise” used herein indicate existence of corresponding features (e.g., elements such as numeric values, functions, operations, or components) but do not exclude presence of additional features.

In the disclosure disclosed herein, the expressions “A or B”, “at least one of A or/and B”, or “one or more of A or/and B”, and the like used herein may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The expressions such as “1st”, “2nd”, “first”, or “second”, and the like used in various embodiments of the present disclosure may refer to various elements irrespective of the order and/or priority of the corresponding elements, but do not limit the corresponding elements. The expressions may be used to distinguish one element from another element. For instance, both “a first user device” and “a second user device” indicate different user devices from each other irrespective of the order and/or priority of the corresponding elements. For example, a first component may be referred to as a second component and vice versa without departing from the scope of the present disclosure.

It will be understood that when an element (e.g., a first element) is referred to as being “(operatively or communicatively) coupled with/to” or “connected to” another element (e.g., a second element), it can be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there are no intervening element (e.g., a third element).

Depending on the situation, the expression “configured to” used herein may be used as, for example, the expression “suitable for”, “having the capacity to”, “designed to”, “adapted to”, “made to”, or “capable of”. The term “configured to” must not mean only “specifically designed to” hardwarily. Instead, the expression “a device configured to” may mean that the device is “capable of” operating together with another device or other components. For example, a “processor configured to perform A, B, and C” may mean a generic-purpose processor (e.g., a central processing unit (CPU) or an application processor) which may perform corresponding operations by executing one or more software programs which stores a dedicated processor (e.g., an embedded processor) for performing a corresponding operation.

Terms used in this specification are used to describe specified embodiments of the present disclosure and are not intended to limit the scope of the present disclosure. The terms of a singular form may include plural forms unless otherwise specified. Unless otherwise defined herein, all the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal detect unless expressly so defined herein in various embodiments of the present disclosure. In some cases, even if terms are terms which are defined in the specification, they may not be interpreted to exclude embodiments of the present disclosure.

Electronic devices according to various embodiments of the present disclosure may include at least one of, for example, smart phones, tablet personal computers (PCs), mobile phones, video telephones, electronic book readers, desktop PCs, laptop PCs, netbook computers, workstations, servers, personal digital assistants (PDAs), portable multimedia players (PMPs), Motion Picture Experts Group (MPEG-1 or MPEG-2) Audio Layer 3 (MP3) players, mobile medical devices, cameras, or wearable devices. According to various embodiments, the wearable devices may include at least one of accessory-type wearable devices (e.g., watches, rings, bracelets, anklets, necklaces, glasses, contact lenses, or head-mounted-devices (HMDs)), fabric or clothing integral wearable devices (e.g., electronic clothes), body-mounted wearable devices (e.g., skin pads or tattoos), or implantable wearable devices (e.g., implantable circuits).

In various embodiments, the electronic devices may be smart home appliances. The smart home appliances may include at least one of, for example, televisions (TVs), digital versatile disk (DVD) players, audios, refrigerators, air conditioners, cleaners, ovens, microwave ovens, washing machines, air cleaners, set-top boxes, home automation control panels, security control panels, TV boxes (e.g., Samsung HomeSync™, APPLE TV®, or GOOGLE TV®), game consoles (e.g., XBOX® and PLAYSTATION®), electronic dictionaries, electronic keys, camcorders, or electronic picture frames.

In various embodiments, the electronic devices may include at least one of various medical devices (e.g., various portable medical measurement devices (e.g., blood glucose meters, heart rate meters, blood pressure meters, or thermometers, and the like), a magnetic resonance angiography (MRA), a magnetic resonance imaging (MRI), a computed tomography (CT), scanners, or ultrasonic devices, and the like), navigation devices, global navigation satellite system (GNSS), event data recorders (EDRs), flight data recorders (FDRs), vehicle infotainment devices, electronic equipment for vessels (e.g., navigation systems, gyrocompasses, and the like), avionics, security devices, head units for vehicles, industrial or home robots, automatic teller's machines (ATMs), points of sales (POSs), or internet of things (e.g., light bulbs, various sensors, electric or gas meters, sprinkler devices, fire alarms, thermostats, street lamps, toasters, exercise equipment, hot water tanks, heaters, boilers, and the like).

According to various embodiments, the electronic devices may include at least one of parts of furniture or buildings/structures, electronic boards, electronic signature receiving devices, projectors, or various measuring instruments (e.g., water meters, electricity meters, gas meters, or wave meters, and the like). The electronic devices according to various embodiments of the present disclosure may be one or more combinations of the above-mentioned devices. The electronic devices according to various embodiments of the present disclosure may be flexible electronic devices. Also, electronic devices according to various embodiments of the present disclosure are not limited to the above-mentioned devices, and may include new electronic devices according to technology development

Hereinafter, electronic devices according to various embodiments will be described with reference to the accompanying drawings. The term “user” used herein may refer to a person who uses an electronic device or may refer to a device (e.g., an artificial electronic device) that uses an electronic device.

FIGS. 1A and 1B illustrate an environment where an electronic device operates according to an embodiment.

Referring to FIG. 1A, an electronic device 100 may capture a photo or video for an object 20 to be captured, by an operation of its user 10. The electronic device 100 may include a display 110. The display 110 may be a curved display of a form which covers four surfaces of the electronic device 100. In FIG. 1, an embodiment of the present disclosure is exemplified as the display 110 has a form of covering the four surfaces of the electronic device 100. However, embodiments of the present disclosure are not limited thereto. For example, the display 110 may be implemented in the form of covering three surfaces (e.g., a front surface, a left side surface, and a right side surface) of the electronic device 100. The electronic device 100 may detect a touch input on any point of the display 110. The electronic device 100 may detect a touch input through a finger of the user 10 to recognize a holding form of the user 10. If recognizing a designated holding shape, for example, a holding shape shown in FIG. 1 (e.g., a shape where the user 10 touches a plurality of points on edges of both sides of the electronic device 100 and holding the electronic device 100 with his or her both hands), the electronic device 100 may execute a camera application. The electronic device 100 may activate a rear camera based on the holding shape of the user 10. The electronic device 100 may output a preview image for the object 20 captured by the rear camera on a front region of the display 110. If detecting a touch input on a right top end of the display 110, the electronic device 100 may capture and store a photo for the object 20 to be captured.

Referring to FIG. 1B, the electronic device 100 may output the preview image shown in FIG. 1A on a rear region of the display 110 as well as the front region of the display 110. For example, if detecting a flicking input directed from the front region of the display 110 to the rear surface of the display 110 on the right top end of the display 110 (e.g., an input where a touch event which touches the front region is dragged and dropped onto the rear region), the electronic device 100 may output the preview image output on the front region on the rear region of the display 110. The object 20 to be captured may verify the preview image output on the rear region.

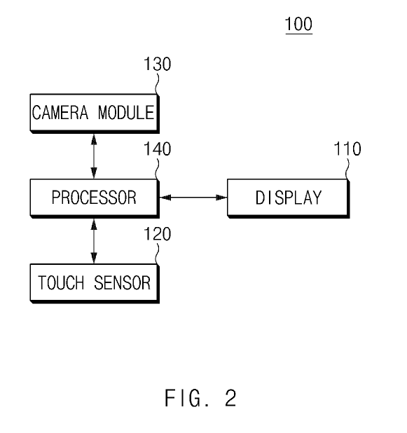

FIG. 2 illustrates a configuration of an electronic device according to an embodiment.

Referring to FIGS. 1A, 1B, and 2, the electronic device 100 may include the display 110, a touch sensor 120, a camera module 130, and a processor 140.

The display 110 may include a first surface, a second surface connected with an edge of the first surface, a third surface connected with an edge of the second surface, and a fourth surface connected with an edge of the first surface and an edge of the third surface. Alternatively, the display 110 may include a front surface, a side surface connected with an edge of the front region, and a rear surface connected with an edge of the side region. The display 110 may include, for example, the front surface (the first surface), the rear region (the third surface), a first side region (the second surface) for connecting a right edge of the front region (the first surface) with a left edge of the rear region (the third surface), and a second side region (the fourth surface) for connecting a left edge of the front region (the first surface) with a right edge of the rear region (the third surface). The front region, the side region, and the rear region of the display 110 may be implemented as a structure of connecting with each other. According to an embodiment, the display 110 may be a wraparound display. The display 110 may be configured to cover the electronic device 100 in various forms, for example, a track shape, a circle, an oval, or a rectangle, and the like. The terms “front region”, “first side region”, “second side region”, and “rear region” are used for convenience of description. The display 110 may be implemented in the form where a “front surface”, a “first side surface”, a “second side surface”, and a “rear surface” are not distinguished from each other. In this case, it should be interpreted that the term “front region” has the same meaning as the term “first surface”, that the term “first side region” has the same meaning as the term “second surface”, that the term “second side region” has the same meaning as the term “fourth surface”, and that the term “rear region” has the same meaning as the term “third surface”.

According to an embodiment, the display 110 may be configured with one panel and may be configured with a plurality of panels connected with each other. For one example, each of the front region, the side region, and the rear region of the display 110 may be configured with a separate panel. For another example, the front region, the side region, and the rear region of the display 110 may be configured with one panel. For another example, the front region and part of the side region of the display 110, shown from the front of the electronic device 100, may be configured with one panel, and the rear region and the other part of the side region of the display 110, shown from the rear of the electronic device 100, may be configured with one panel.

According to an embodiment, a partial region of the display 110 may be activated, or the entire region of the display 110 may be activated. For one example, the front region, the side region, or the rear region of the display 110 may be selectively activated. For another example, the front region and part of the side region of the display 110, shown from the front of the electronic device 100, may be activated. For another example, the rear region and part of the side region of the display 110, shown from the rear of the electronic device 100, may be activated.

The touch sensor 120 may sense a touch input on any point of the display 110. In detail, the touch sensor 120 may sense touch inputs on the front region, the side region, and the rear region. According to an embodiment, the touch sensor 120 may sense a touch input in a state (an OFF state) where the display 110 is deactivated as well as a state (an ON state) where the display 110 is activated.

The camera module 130 may obtain an image for an object to be captured. The camera module 130 may include a front camera installed in the front of the electronic device 100 and a rear camera installed in the rear of the electronic device 100. According to an embodiment, if a plurality of touch inputs on designated locations are obtained by the touch sensor 120, the camera module 130 may be activated. According to an embodiment, the front camera and the rear camera of the camera module 130 may be selectively activated. According to an embodiment, zoom magnification of the camera module 130 may be adjusted by a touch input on the touch sensor 120.

The processor 140 may electrically connect with the display 110, the touch sensor 120, and the camera module 130. The processor 140 may control the display 110, the touch sensor 120, and the camera module 130. The processor 140 may output a screen on the display 110. Also, the processor 140 may obtain a touch input using the touch sensor 120 and may obtain an image using the camera module 130.

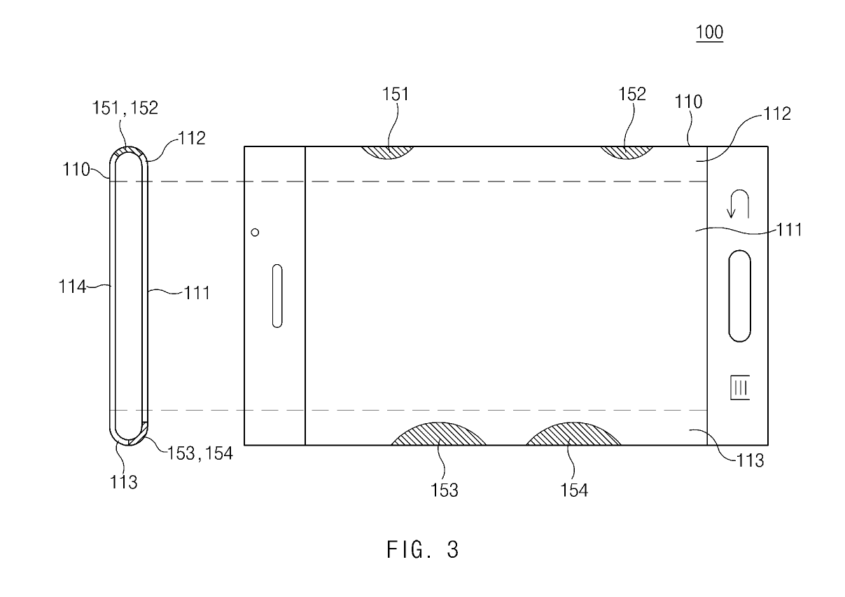

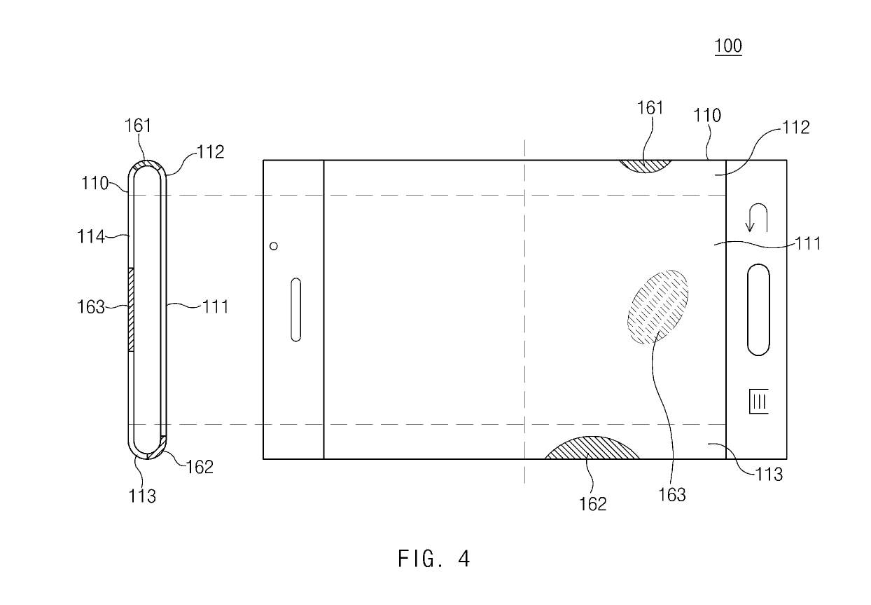

According to an embodiment, the processor 140 may obtain a plurality of touch inputs using the touch sensor 120. If obtaining a plurality of touch inputs on designated locations, the processor 140 may activate the camera module 130. If obtaining the plurality of touch inputs on the designated locations, the processor 140 may execute a camera application and may obtain a preview image using the camera module 130. In the disclosure, the preview image may include an image provided to the display 110 while the camera module 130 is activated. Also, the preview image may include an image for showing a user of the electronic device 100 an image to be captured by the camera module 130 in advance if an image capture command is received. A description will be given in detail for the designated locations with reference to FIGS. 3 and 4.

According to an embodiment, the processor 140 may obtain a touch input using the touch sensor 120 in a state where the display 110 is deactivated. The processor 140 may obtain, for example, a touch input using the touch sensor 120 in a low-power mode where the display 110 is deactivated. The processor 140 may obtain a plurality of touch inputs in the low-power mode. Also, if obtaining the plurality of touch inputs on the designated locations, the processor 140 may activate the camera module 130.

According to an embodiment, after one of a plurality of touch inputs is changed, the processor 140 may obtain an additional input corresponding to the changed input. The processor 140 may detect a change of one of a plurality of touch inputs which activates the camera module 130, using the touch sensor 120. For one example, the processor 140 may detect that one of the plurality of touch inputs is released. The processor 140 may obtain an additional input corresponding to the released touch input. The input corresponding to the released touch input may include an input provided within a designated distance from a coordinate of the released touch input. For another example, the processor 140 may detect that one of the plurality of touch inputs slides and a coordinate of the touch input is changed. The processor 140 may obtain an input of a type, for example, short tap, long tap, double tap, drag, flicking, pinch-in, or pinch-out, as an additional input. The processor 140 may obtain an input of a direction, for example, a transverse direction, a longitudinal direction, or a diagonal direction, as an additional input.

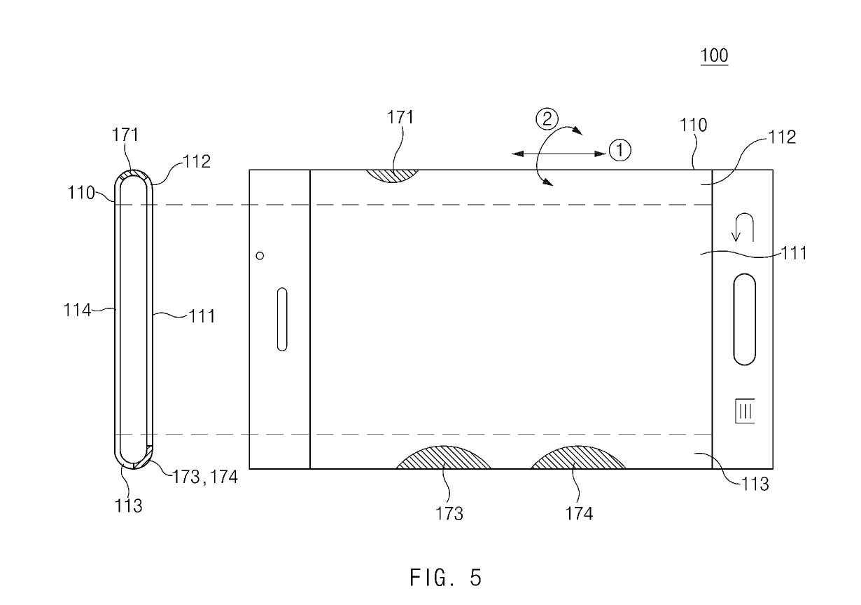

According to an embodiment, the processor 140 may execute a function mapped with an input pattern of the additional input based on the input pattern of the additional input. The processor 140 may execute a function mapped with an input type or an input direction of the additional input based on the input type or the input direction of the additional input. The processor 140 may execute, for example, a function based on at least one of a time point, an end point, an area, or duration of the additional input. A description will be given in detail for the function executed by the input pattern of the additional input and the additional input with reference to FIG. 5.

According to an embodiment, the processor 140 may recognize a face of an object to be captured, from a preview image obtained by the camera module 130. The processor 140 may provide content based on previously stored information for the recognized object to be captured. The processor 140 may recognize the face of the object to be captured included in a preview image by analyzing the preview image using a face recognition algorithm. If recognizing the face of the object to be captured, the processor 140 may provide content mapped with the recognized object to be captured. For example, if recognizing a face of an infant from a preview image, the processor 140 may concentrate attention of the object to be captured by outputting content including an animation character on the rear region of the display 110.

FIG. 3 illustrates an electronic device and a region where a touch input is received on a display of the electronic device according to an embodiment.

Referring to FIG. 3, an electronic device 100 may include a display 110 including a front region 111 (a first surface), a first side region 112 (a second surface), a second side region 113 (a fourth surface), and a rear region 114 (a third surface). The display 110 may be implemented with, as shown in FIG. 3, a track shape which covers the electronic device 100. A first touch input 151 and a second touch input 152 may be received on the first side region 112, and a third touch input 153 and a fourth touch input 154 may be received on the second side region 113.

According to an embodiment, the electronic device 100 (e.g., a processor 140 of FIG. 2) may activate a camera module 130 of FIG. 2 based on locations of a plurality of touch inputs 151 to 154. The electronic device 100 may be held by both hands of a user of the electronic device 100 such that its camera is towards the front of the electronic device 100 and at least part of the display 110 does not block his or her view. In this case, the electronic device 100 may determine that the user has intention to capture a photo or video and may activate the camera module 130.

For example, if the two touch inputs 151 and 152 are received on the first side region 112 and if the two touch inputs 153 and 154 are received on the second side region 113, the electronic device 100 may activate the camera module 130. The user may make contact with a top end of the electronic device 100 with forefingers of his or her both hands and may make contact with a bottom end of the electronic device 100 with thumbs of his or her both hands to capture an object. In this case, a distance between the forefingers of both hands of the user may be longer than a distance between the thumbs of his or her both hands. Therefore, only if a distance between the first touch input 151 and the second touch input 152 provided to the top end of the electronic device 100 is longer than a distance between the third touch input 153 and the fourth touch input 154 provided to the bottom end of the electronic device 100, the electronic device 100 may activate the camera module 130. Also, an area of a touch input by a thumb of the user may be larger than that of a touch input by his or her forefinger. Therefore, only if an input area of each of the third touch input 153 and the fourth touch input 154 provided to the bottom end of the electronic device 100 is larger than an input area of each of the first touch input 151 and the second touch input 152 provided to the top end of the electronic device 100, the electronic device 100 may activate the camera module 130.

According to an embodiment, the electronic device 100 (e.g., the processor 140) may selectively activate a front camera or a rear camera of the camera module 130 based on input locations of the plurality of touch inputs 151 to 154. If the user holds the electronic device 100 using his or her thumb and forefinger, his or her thumb may be located to be close to his or her face. If the user requests to quickly execute a camera of the electronic device 100, he or she may intend to capture an object which is in his or her view. Therefore, the electronic device 100 may activate the front camera or the rear camera based on whether an input location of each of the plurality of touch inputs 151 to 154 is close to any of the front region 111 and the rear region 114. For example, as shown in FIG. 3, if each of input locations of the third touch input 153 and the fourth touch input 154 which has a relatively larger input area among the plurality of touch inputs 151 to 154 is closer to the front region 111 than the rear region 114, the electronic device 100 may activate the rear camera. Also, if each of the input locations of the third touch input 153 and the fourth touch input 154 is closer to the rear region 114 than the front region 111, the electronic device 100 may activate the front camera.

According to an embodiment, the electronic device 100 (e.g., the processor 140) may selectively activate the front region 111 or the rear region 114 based on the input locations of the plurality of touch inputs 151 to 154. The electronic device 100 may output a preview image obtained by the camera module 130 on the activated region. If the user holds the electronic device 100 using his or her forefinger and thumb, the thumb may be located to be close to his or her face. If a display region located in the direction of a face of the user is activated, he or she may verify a preview image. Therefore, the electronic device 100 may activate the front region 111 or the rear region 114 based on whether each of the input locations of the plurality of touch inputs 151 to 154 is close to any of the front region 111 and the rear region 114. For example, as shown in FIG. 3, if each of the input locations of the third touch input 153 and the fourth touch input 154 which has a relatively larger input area among the plurality of touch inputs 151 to 154 is closer to the front region 111 than the rear region 114, the electronic device 100 may output a preview image on the front region 111. Also, if each of the input locations of the third touch input 153 and the fourth touch input 154 is closer to the rear region 114 than the front region 111, the electronic device 100 may output a preview image on the rear region 114.

In FIG. 3, an embodiment of the present disclosure is exemplified as the electronic device 100 activates the camera module 130 if the two touch inputs 151 and 152 are received on the first side region 112 and if the two touch inputs 153 and 154 are received on the second side region 113. However, embodiments of the present disclosure are not limited thereto. For example, a designated region where the electronic device 100 may activate the camera module 130 may be set in various ways.

Also, in FIG. 3, an embodiment of the present disclosure is exemplified as the display 110 is implemented with a track shape. Embodiments of the present disclosure are not limited thereto. For example, the display 110 may have any shape, such as a circle, an oval, or a rectangle, implemented to cover the electronic device 100. Also, in FIG. 3, an embodiment of the present disclosure is exemplified as the display 110 is in the form of covering four surfaces of the electronic device 100. Embodiments of the present disclosure are not limited thereto. For example, the display 110 may be implemented in the form of covering three surfaces (e.g., a front surface, a left side surface, and a right side surface).

FIG. 4 illustrates an electronic device and a region where a touch input is received on a display of the electronic device according to an embodiment.

Referring to FIG. 4, an electronic device 100 may include a display 110 including a front region 111, a first side region 112, a second side region 113, and a rear region 114. A first touch input 161 may be received on the first side region 112. A second touch input 162 may be received on the second side region 113. A third touch input 163 may be received on the rear region 114.

According to an embodiment, the electronic device 100 (e.g., a processor 140 of FIG. 2) may activate a camera module 130 of FIG. 2 based on locations of the plurality of touch inputs 161 to 163. The electronic device 100 may be held by one hand of a user of the electronic device 100 such that its camera is towards the front of the electronic device 100 and the display 110 does not block his or her view. In this case, the electronic device 100 may determine that the user has intention to capture a photo or video and may activate the camera module 130.

For example, if the first touch input 161 is received on the first side region 112, if the second touch input 162 is received on the second side region 113, and if the third touch input 163 is received on the rear region 114, the electronic device 100 may activate the camera module 130. The user may make contact with a top end of the electronic device 100 with his or her forefinger, may make contact with a bottom end of the electronic device 100 with his or her thumb, and may make contact with a rear surface of the electronic device 100 with his or his middle finger. In this case, an area of the touch input by the middle finger may be larger than an area of the touch input by the thumb, and the area of the touch input by the thumb may be larger than an area of a touch input by the forefinger. If an input area of the second touch input 162 provided to the bottom end of the electronic device 100 is larger than an input area of the first touch input 161 provided to the top end of the electronic device 100, the electronic device 100 may activate the camera module 130. Also, if an input area of the third touch input 163 provided to the rear region 114 is larger than an input area of each of the first touch input 161 and the second touch input 162, the electronic device 100 may activate the camera module 130. Also, all of the plurality of touch inputs 161 to 163 are provided to a right region (or a left region) of the display 110, the electronic device 100 may activate the camera module 130.

According to an embodiment, the electronic device 100 (e.g., the processor 140) may selectively activate a front camera or a rear camera of the camera module 130 based on input locations of the plurality of touch inputs 161 to 163. For example, as shown in FIG. 4, if an input location of the second touch input 162 which has a relatively larger input area between the first and second touch inputs 161 and 162 respectively provided to the first and second side regions 112 and 113 is closer to the front region 111 than the rear region 114, the electronic device 100 may activate the rear camera. Also, as shown in FIG. 4, if the third touch input 163 which has the largest input area among the plurality of touch inputs 161 to 163 is provided to the rear region 114, the electronic device 100 may activate the rear camera. Also, if the input location of the second touch input 162 which has a relatively larger input area between the first and second touch inputs 161 and 162 respectively provided to the first and second side regions 112 and 113 is closer to the rear region 114 than the front region 111, the electronic device 100 may activate the front camera. If the third touch input 163 which has the largest input area among the plurality of touch inputs 161 to 163 is provided to the front region 111, the electronic device 100 may activate the front camera.

According to an embodiment, the electronic device 100 (e.g., the processor 140) may selectively activate the front region 111 or the rear region 114 based on the input locations of the plurality of touch inputs 161 to 163. The electronic device 100 may output a preview image obtained by the camera module 130 on the activated region. For example, if the input location of the second touch input 162 which has a relatively larger input area between the first and second touch inputs 161 and 162 respectively provided to the first and second side regions 112 and 113 is closer to the front region 111 than the rear region 114, the electronic device 100 may output a preview image on the front region 111. Also, if the third touch input 163 which has the largest input area among the plurality of touch inputs 161 to 163 is provided to the rear region 114, the electronic device 100 may output a preview image on the front region 111. Also, if the input location of the second touch input 162 which has a relatively larger input area between the first and second touch inputs 161 and 162 respectively provided to the first and second side regions 112 and 113 is closer to the rear region 114 than the front region 111, the electronic device 100 may output a preview image on the rear region 114. If the third touch input 163 which has the largest input area among the plurality of touch inputs 161 to 163 is provided to the front region 111, the electronic device 100 may output a preview image on the rear region 114.

FIG. 4 exemplifies an embodiment of the present disclosure in which the electronic device 100 activates the camera module 130 when the first touch input 161 is received on the first side region 112, the second touch input 162 is received on the second side region 113, and the third touch input 163 is received on the rear region 114. However, embodiments of the present disclosure are not limited thereto. For example, a designated region where the electronic device 100 may activate the camera module 130 may be set in various ways.

Also, FIG. 4 exemplifies an embodiment of the present disclosure where the display 110 is implemented with a track shape. Embodiments of the present disclosure are not limited thereto. For example, the display 110 may have any shape, such as a circle, an oval, or a rectangle, implemented to cover the electronic device 100. Also, FIG. 4 exemplifies an embodiment of the present disclosure where the display 110 is in the form of covering four surfaces of the electronic device 100. Embodiments of the present disclosure are not limited thereto. For example, the display 110 may be implemented in the form of covering three surfaces (e.g., a front surface, a left side surface, and a right side surface).

FIG. 5 illustrates an electronic device and a region where a touch input is received on a display of the electronic device according to an embodiment.

Referring to FIG. 5, an electronic device 100 may include a display 110 including a front region 111, a first side region 112, a second side region 113, and a rear region 114. A first touch input 151 may be received on the first side region 112. A third touch input 153 and a fourth touch input 154 may be received on the second side region 113. A touch input (e.g., drag or flicking) in a first direction \textcircled{1} (e.g., a longitudinal direction of the first side region 112) or a touch input (e.g., drag or flicking) in a second direction \textcircled{2} (e.g., a rear direction from the front of the first side region 112 or a front direction from the rear of the first side region 112) may be received on the first side region 112. A user of the electronic device 100 may change one of a plurality of touch inputs and may maintain the other touch inputs to execute a function while maintaining a state where he or she holds the electronic device 100.

According to an embodiment, if an additional input is a tap input on the first side region 112, the electronic device 100 (e.g., a processor 140 of FIG. 2) may capture a photo or video via a camera module 130 of FIG. 2. The tap input may include a press motion and a release motion on a specific point of the display 110. For example, after a second touch input 152 shown in FIG. 3 is released, the electronic device 100 may obtain an additional input on a location corresponding to the second touch input 152. The location corresponding to the second touch input 152 may include a location within a designated distance from a coordinate of the second touch input 152. If obtaining a tap input as an additional input, the electronic device 100 may capture a photo or video using the camera module 130. If obtaining a long tap input which continues for a designated time or more as an additional input, the electronic device 100 may perform continuous image capture using the camera module 130.

According to an embodiment, if an additional input is a drag input in a first direction on the first side region 112, the electronic device 100 (e.g., the processor 140) may adjust sensitivity of the camera module 130. The first direction may be a direction horizontal with a boundary between the front region 111 and the rear region 114. The first direction may be a direction within a designated angle with the direction horizontal with the boundary between the front region 111 and the rear region 114. The drag input may be an input which performs a press motion on a first point of the display 110 (e.g., a region located at the front region 111 on the first side region 112), moves from the first point to a second point (e.g., a region located at the rear region 114 on the first side region 112), and performs a release motion on the second point. For one example, after the second touch input 152 shown in FIG. 3 is released, the electronic device 100 may obtain a drag input in the first direction on a location corresponding to the second touch input 152. For another example, the electronic device 100 may obtain a drag input in the first direction which has the second touch input 152 as a start point in a state where the second touch input 152 is maintained. If a direction of the drag input is a left direction, the electronic device 100 may decrease (or increase) sensitivity of the camera module 130. If a direction of the drag input is a right direction, the electronic device 100 may increase (or decrease) sensitivity of the camera module 130.

According to an embodiment, if an additional input is a drag input in the first direction on the first side region 112, the electronic device 100 (e.g., the processor 140) may adjust zoom magnification of the camera module 130. If a direction of the drag input is a left direction, the electronic device 100 may decrease (or increase) zoom magnification of the camera module 130. If a direction of the drag input is a right direction, the electronic device 100 may increase (or decrease) zoom magnification of the camera module 130.

According to an embodiment, if an additional input is a flicking input in the second direction on the first side region 112, the electronic device 100 (e.g., the processor 140) may simultaneously output a preview image obtained via the camera module 130 on the front region 111 and the rear region 114. The second direction may be a direction vertical to the first direction. The second direction may be a direction within a designated angle with a direction vertical to the first direction. The flicking input may be an input which performs a press motion on a first point of the display 110 within a designated time or at a faster speed than the designated speed and performs a release motion on a second point after moving from the first point to the second point. For one example, after the second touch input 152 shown in FIG. 3 is released, the electronic device 100 may obtain a flicking input in the second direction on a location corresponding to the second touch input 152. For another example, the electronic device 100 may obtain a flicking input in the second direction which has the second touch input 152 shown in FIG. 3 as a start point in a state where the second touch input 152 is maintained. If a flicking input from the front of the electronic device 100 to the rear of the electronic device 100, the electronic device 100 may output a preview image output on the front region 111 on the rear region 114.

According to an embodiment, if obtaining a flicking input in the first direction on the first side region as an additional input in a state where a front camera of the electronic device 100 is activated, the electronic device 100 (e.g., the processor 140) may activate the rear camera. For example, if a flicking input from the front of the electronic device 100 to the rear of the electronic device 100, the electronic device 100 may activate the rear camera.

According to an embodiment, if obtaining a flicking input in the second direction on the first side region 112 as an additional input in a state where the rear camera is activated, the electronic device 100 may activate the front camera. For example, if obtaining a flicking input from the rear of the electronic device 100 to the front of the electronic device 100, the electronic device 100 may activate the front camera.

Additional inputs having various input patterns and various functions may be mapped with each other, other than the additional input having the above-mentioned input pattern. For one example, if obtaining a pinch-zoom in input for widening a distance between the first touch input 151 and the second touch input 152 shown in FIG. 3, the electronic device 100 may zoom in on a preview image displayed on the display 110. For another example, if obtaining a pinch-zoom out input for narrowing a distance between the first touch input 151 and the second touch input 152 shown in FIG. 3, the electronic device 100 may zoom out on a preview image displayed on the display 110.

According to various embodiments, an electronic device may include a display configured to include a front region, a side region connected with an edge of the front region, and a rear region connected with an edge of the side region, a touch sensor configured to sense a touch input on a first surface, a second surface, a third surface, or a fourth surface, a camera module configured to obtain an image for an object to be captured, and a processor configured to electronically connect with the display, the touch sensor, and the camera module. The processor may be configured to activate the camera module, to obtain a touch input using the touch sensor, and to execute a function corresponding to a location of the touch input or an input pattern of the touch input.

For example, if obtaining a tap input on a right top region via the touch sensor in a state where the camera module is activated, the electronic device may capture a photo or video using the camera module. For another example, if obtaining a drag input (or a flicking input) in a direction horizontal with a boundary between a side region and a front region on a left top region via the touch sensor, the electronic device may adjust sensitivity of the camera module. For another example, if obtaining a drag input (or a flicking input) in a direction horizontal with a boundary between the side region and the front region on a right top region via the touch sensor, the electronic device may adjust zoom magnification of the camera module. For another example, if obtaining a flicking input (or a drag input) in a direction vertical to the boundary between the side region and the front region on the right top region via the touch sensor, the electronic device may simultaneously output a preview image obtained by the camera module on the front region and a rear region.

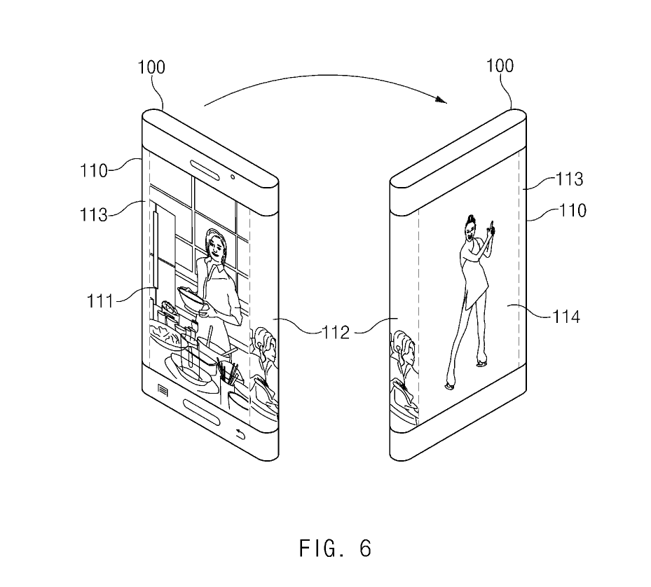

FIG. 6 is a drawing illustrating an exemplary implementation in which an image is output on a display of an electronic device according to an embodiment.

Referring to FIG. 6, an electronic device 100 may output an image throughout all of a front region 111, a first side region 112, and a rear region 114 of a display 110. The electronic device 100 may further include a second side region 113 connected with the front region 111 and the rear region 114. The electronic device 100 may output an image throughout all of the front region 111, the first side region 112, the second side region 113, and the rear region 114 of the display 110.

According to an embodiment, if a photo or video is captured by a camera module 130 of FIG. 2, the electronic device 100 (e.g., a processor 140 of FIG. 2) may output the captured image or video throughout all of the front region 111, the first side region 112, the second side region 113, and the rear region 114. The electronic device 100 may output an image with a structure of being circulated throughout the entire region of the display 110. If obtaining a drag input in a transverse direction of the display 110, the electronic device 100 may scroll and output an image.

Although not illustrated in FIG. 6, the electronic device 100 may output thumbnails of captured images with a structure of being circulated throughout the entire region of the display 110. According to various embodiments, the electronic device 100 may alternately output a preview image at a period on the front region 111 and the rear region 114. Also, if image capturing is completed, the electronic device 100 may alternately output the captured image at a period on the front region 111 and the rear region 114. According to various embodiments, the electronic device 100 may move and display a captured image or a preview image throughout the front region 111, the first side region 112, the rear region 114, and the second side region 113. The electronic device 100 may move and display an image during a designated time. If the designated time elapses, the electronic device 100 may fix and output the image on at least one of the front region 111 or the rear region 114. Also, if the designated time elapses, the electronic device 100 may configure a screen including thumbnail screens of previously captured images and a currently captured image and may output the configured screen on at least one of the front region 111, the first side region 112, the rear region 114, and the second side region 113.

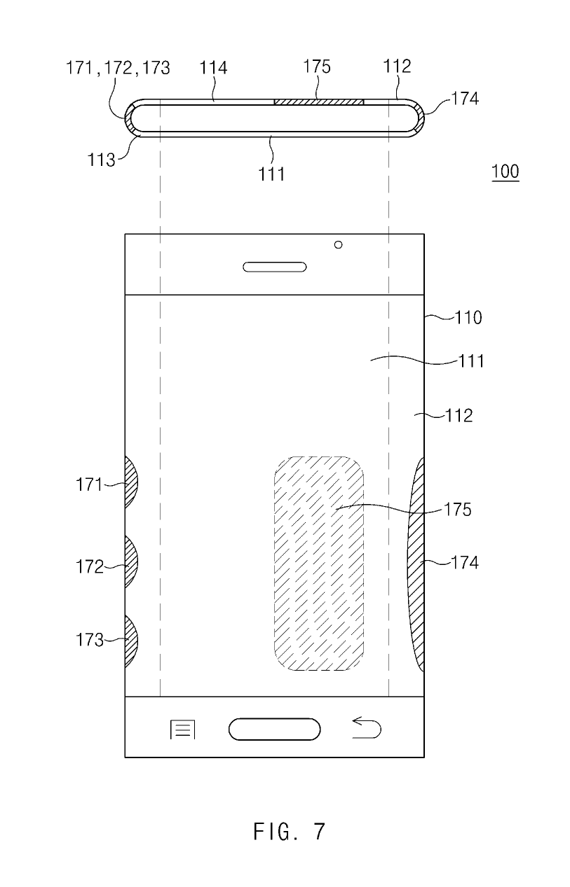

FIG. 7 illustrates an electronic device and a region where a touch input is received on a display of the electronic device according to an embodiment.

Referring to FIG. 7, an electronic device 100 may include a display 110 including a front region 111, a first side region 112, a second side region 113, and a rear region 114. A first touch input 171, a second touch input 172, and the third touch input 173 may be received on the second side region 113. A fourth touch input 174 may be received on the first side region 112. A fifth touch input 175 may be received on the rear region 114.

According to an embodiment, the electronic device 100 (e.g., a processor 140 of FIG. 2) may determine a display location of a user interface displayed on the display 110 based on input locations of the plurality of touch inputs 171 to 175. If there are relatively many touch points obtained on a left region of the display 110 in comparison with touch points obtained on a right region of the display 110 (or if a touch area of the left region is relatively smaller than that of the right region), the electronic device 100 may determines that its user holds the electronic device 100 with his or her right hand. If determining that the user holds the electronic device 100 with his or her right hand, the electronic device 100 may display a user interface on the right region of the display 110 such that he or she provides a touch input on the user interface with his or her thumb of the right hand. If there are relatively many touch points obtained on the right region of the display 110 in comparison with touch points obtained on the left region of the display 110 (or if a touch area of the right region is relatively smaller than that of the left region), the electronic device 100 may determines that the user holds the electronic device 100 with his or her left hand. If determining that the user holds the electronic device 100 with his or her left hand, the electronic device 100 may display a user interface on the left region of the display 110 such that he or she provides a touch input on the user interface with his or her thumb of the left hand.

For one example, as shown in FIG. 7, if the plurality of touch inputs 171 to 173 are provided to the second side region 113 and if the fourth touch input 174 and the fifth touch input 175 are respectively provided to the first side region 112 and the rear region 114, the electronic device 100 may determine that the user holds the electronic device 100 with his or her right hand. In this case, the electronic device 100 may display a user interface on a right region of the front region 111 or the first side region 112.

For another example, if the plurality of touch inputs are provided to the first side region 112 and if one touch input is provided to each of the second side region 113 and the rear region 114, the electronic device 100 may determine that the user holds the electronic device 100 with his or her left hand. In this case, the electronic device 100 may display a user interface on a left region of the front region 111 or the second side region 113.

According to various embodiments, the electronic device 100 may determine locations of its top and bottom surfaces and may execute a function based on the locations of the top and bottom surfaces. The electronic device 100 may determine the locations of the top and bottom surfaces based on locations of a plurality of touch inputs. For one example, since a thumb of the user is located to be lower than the other fingers, the electronic device 100 may determine a portion to which a touch input having a larger area among a plurality of touch inputs is provided as the top surface and may determine a portion to which a touch input having a smaller area is provided as the bottom surface. For another example, the electronic device 100 may determine the locations of the top and bottom surfaces based on information sensed by a gravity sensor included in the electronic device 100. The electronic device 100 may rotate an output screen based on the locations of the top and bottom surfaces.

According to various embodiments, the electronic device 100 may determine its posture based on locations of a plurality of touch inputs and may execute a function based on the posture. For example, if the plurality of touch inputs are provided to a designated location, the electronic device 100 may determine its posture. The electronic device 100 may change an output location of a user interface based on the posture.

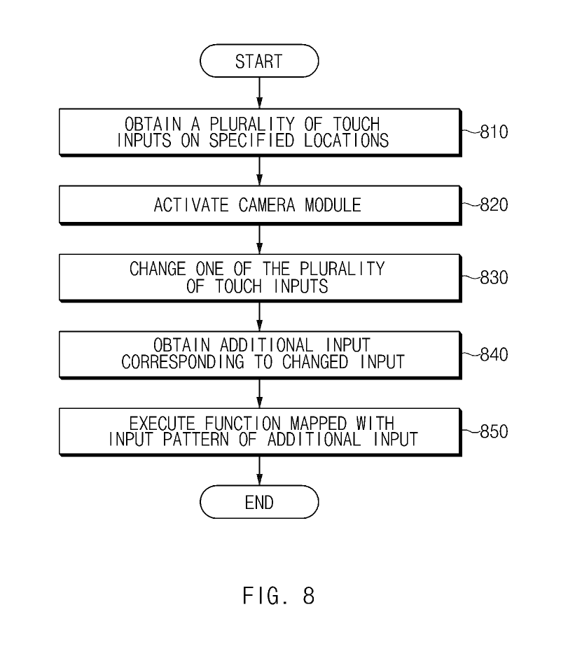

FIG. 8 illustrates a camera control method of an electronic device according to an embodiment.

Operations shown in FIG. 8 may include operations processed by an electronic device 100 shown in FIGS. 2 to 7. Therefore, although there are contents omitted below, contents described about the electronic device 100 with reference to FIGS. 2 to 7 may be applied to the operations shown in FIG. 8.

Referring to FIG. 8, in operation 810, an electronic device 100 (e.g., a processor 140) of FIG. 2 may obtain a plurality of touch inputs on designated locations. The designated locations may be set to locations to which touch inputs are usually provided if a user of the electronic device 100 holds the electronic device 100 to capture an image using a camera of the electronic device 100. The electronic device 100 may obtain a plurality of touch inputs on locations displayed in FIG. 3 or 4.

In operation 820, the electronic device 100 (e.g., the processor 140) may activate a camera module 130 of FIG. 2. The electronic device 100 may activate the camera module 130 in response to the plurality of touch inputs on the designated locations. The electronic device 100 may execute, for example, a camera application. The electronic device 100 may output a preview image obtained by the camera module 130 on a display 110 of FIG. 2.

In operation 830, the electronic device 100 (e.g., the processor 140) may detect one of the plurality of touch inputs. The electronic device 100 may detect a change of at least one of the plurality of touch inputs obtained in operation 810. For one example, the electronic device 100 may detect a release of at least one of the plurality of touch inputs. For another example, the electronic device 100 may detect movement of at least one of the plurality of touch inputs.

In operation 840, the electronic device 100 (e.g., the processor 140) may obtain an additional input corresponding to the changed touch input. For one example, the electronic device 100 may obtain a tap input on the same location as that of a released touch input as the additional input. For another example, the electronic device 100 may obtain a drag input, which has a changed touch input as a start point, as the additional input.

In operation 850, the electronic device 100 (e.g., the processor 140) may execute a function mapped with an input pattern of the additional input. The electronic device 100 may execute a function mapped with an input location or an input direction of the additional input. The electronic device 100 may execute, for example, a related function based on at least one of a start point, an end point, an area, or duration of the additional input. The function executed by the additional input may be one of various functions, such as a screen shift function, a camera shift function, a zoom-in function, a zoom-out function, and an image capture function, which may be executed by a camera application.

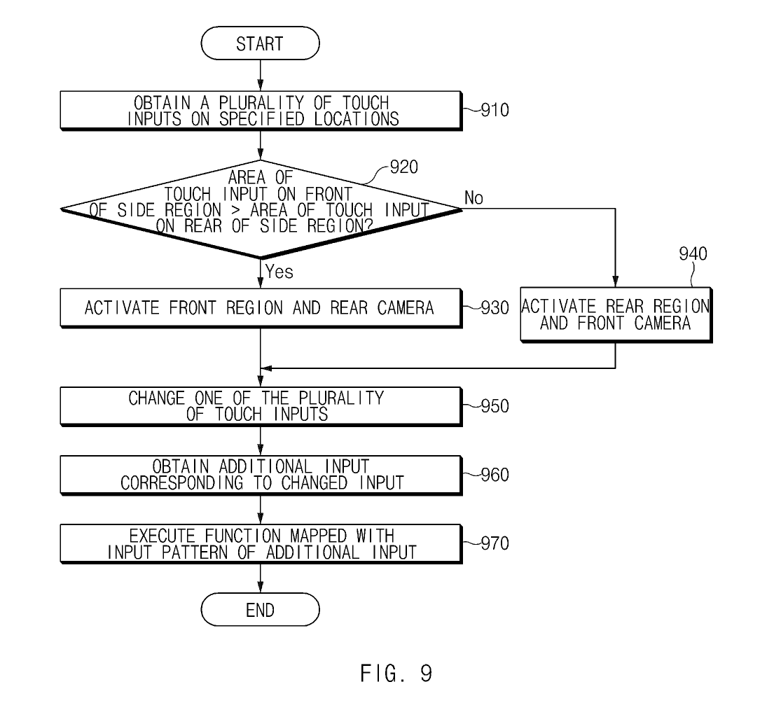

FIG. 9 illustrates a camera control method of an electronic device according to an embodiment. For convenience of description, a repeated description for operations described with reference to FIG. 8 is omitted.

Operations shown in FIG. 9 may include operations processed by an electronic device 100 shown in FIGS. 2 to 7. Therefore, although there are contents omitted below, contents described about the electronic device 100 with reference to FIGS. 2 to 7 may be applied to the operations shown in FIG. 9.

Referring to FIG. 9, in operation 910, the electronic device 100 (e.g., a processor 140 of FIG. 2) may obtain a plurality of touch inputs on designated locations.

In operation 920, the electronic device 100 may compare an area of a touch input on the front of a side region of a display 110 of FIG. 2 with an area of a touch input on the rear of the side region. The front of the side region may include a half adjacent to a front region of the display 110 in the side region of the display 110, and the rear of the side region may include a half adjacent to a rear region of the display 110 in the side region of the display 110. The electronic device 100 may determine a direction in which its user holds the electronic device 100 by comparing the area of the touch input on the front of the side region with the area of the touch input on the rear of the side region. For example, if the area of the touch input on the front of the side region is larger than the area of the touch input on the rear of the side region, the electronic device 100 may determine that the user holds the electronic device 100 such that he or she faces with the front region of the display 110. On the other hand, if the area of the touch input on the rear of the side region is larger than or equal to the area of the touch input on the front of the side region, the electronic device 100 may determine that the user holds the electronic device 100 such that he or she faces with the rear region of the display 110.

If the area of the touch input on the front of the side region of the display 110 is larger than the area of the touch input on the rear of the side region in operation 920, the electronic device 100 may perform operation 930. In operation 930, the electronic device 100 may activate the front region of the display 110 and a rear camera of the camera module 130. If determining that a user's view is in contact with the front of the electronic device 100, the electronic device 100 may activate the front region of the display 110 and may provide a preview image to the user. Also, the electronic device 100 may activate the rear camera and may capture an object to be captured, which is in sight of the user.

In operation 920, if the area of the touch input on the front of the side region of the display 110 is smaller than or equal to the area of the touch input on the rear of the side region, the electronic device 100 may perform operation 940. In operation 940, the electronic device 100 may activate the rear region of the display 110 and a front camera of the camera module 130. If determining that the user's view is in contact with the rear of the electronic device 100, the electronic device 100 may activate the rear region of the display 110 and may provide a preview image to the user. Also, the electronic device 100 may activate the front camera and may capture an object to be captured, which is in sight of the user.

In operation 950, the electronic device 100 (e.g., the processor 140) may detect a change of at least one of the plurality of touch inputs.

In operation 960, the electronic device 100 (e.g., the processor 140) may obtain an additional input corresponding to the changed input.

In operation 970, the electronic device 100 (e.g., the processor 140) may execute a function mapped with an input pattern of the additional input.

According to various embodiments, the electronic device 100 may execute a set function in response to a touch input which occurs on a designated location of a display. For example, the electronic device 100 may include the front region, the rear region, the first side region, and the second side region. If a designated touch input occurs on a designated location (e.g., at least one of both edges) of the first side region (or the second side region), the electronic device 100 may execute a function mapped with the touch input. For example, if a tap input event occurs, the electronic device 100 may automatically activate its camera and may capture an image for an object. Also, if a drag event occurs in a longitudinal direction, the electronic device 100 may adjust a zoom function of the camera. Also, if a drag event occurs in a transverse direction, the electronic device 100 may perform sensitivity adjustment of the camera or a screen shift (e.g., display a screen displayed on the front region on the rear region or shift designated content to the rear region). According to various embodiments, when outputting a screen on the rear region or the front region, the electronic device 100 may adjust a screen size with reference to touch events which are maintained for holding the electronic device 100. For example, the electronic device 100 may adjust a screen as size and shape in which touch points are not included. If touch points are changed, the electronic device 100 may readjust a screen size and shape in response to the changed touch points.

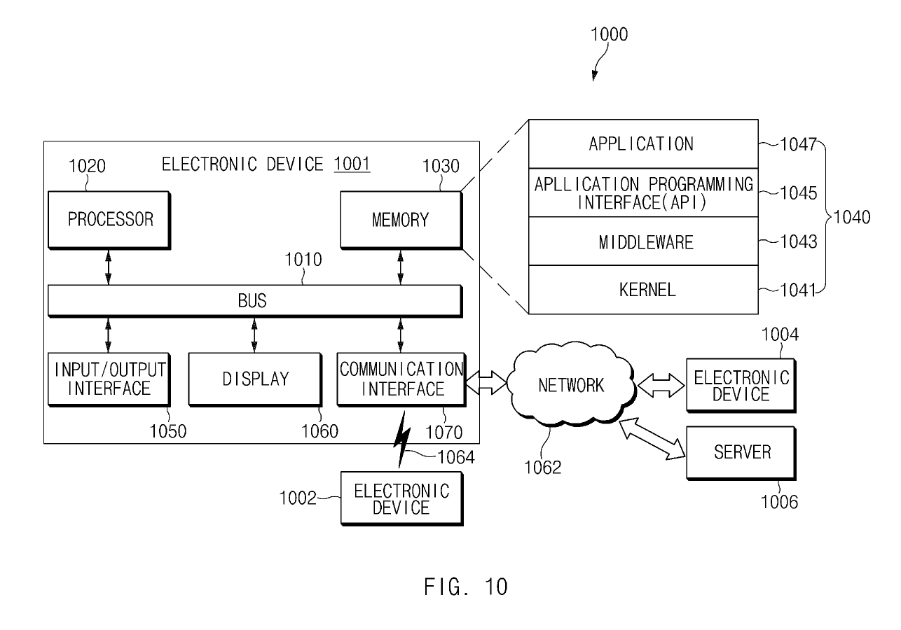

FIG. 10 illustrates a configuration of an electronic device in a network environment according to various embodiments.

Referring to FIG. 10, in various embodiments, an electronic device 1001 and a first external electronic device 1002, a second external electronic device 1004, or a server 1006 may connect with each other over a network 1062 or local-area communication 1064. The electronic device 1001 may include a bus 1010, a processor 1020, a memory 1030, an input/output (I/O) interface 1050, a display 1060, and a communication interface 1070. In various embodiments, at least one of the components of the electronic device 1001 may be omitted from the electronic device 1001, and other components may be additionally included in the electronic device 1001.

The bus 1010 may include, for example, a circuit which connects the components 1020 to 1070 with each other and sends communication (e.g., a control message and/or data) between the components 1020 to 1070.

The processor 1020 may include one or more of a central processing unit (CPU), an application processor (AP), or a communication processor (CP). The processor 1020 may perform, for example, calculation or data processing about control and/or communication of at least another of the components of the electronic device 1001.

The memory 1030 may include a volatile and/or non-volatile memory. The memory 1030 may store, for example, a command or data associated with at least another of the components of the electronic device 1001. According to an embodiment, the memory 1030 may software and/or a program 1040. The program 1040 may include, for example, a kernel 1041, a middleware 1043, an application programming interface (API) 1045, and/or at least one application program 1047 (or “at least one application”), and the like. At least part of the kernel 1041, the middleware 1043, or the API 1045 may be referred to as an operating system (OS).

The kernel 1041 may control or manage, for example, system resources (e.g., the bus 1010, the processor 1020, or the memory 1030, and the like) used to execute an operation or function implemented in the other programs (e.g., the middleware 1043, the API 1045, or the application program 1047). Also, as the middleware 1043, the API 1045, or the application program 1047 accesses a separate component of the electronic device 1001, the kernel 1041 may provide an interface which may control or manage system resources.

The middleware 1043 may play a role as, for example, a go-between such that the API 1045 or the application program 1047 communicates with the kernel 1041 to communicate data with the kernel 1041.

Also, the middleware 1043 may process one or more work requests, received from the at least one application program 1047, in order of priority. For example, the middleware 1043 may assign priority which may use system resources (the bus 1010, the processor 1020, or the memory 1030, and the like) of the electronic device 1001 to at least one of the at least one application program 1047. For example, the middleware 1043 may perform scheduling or load balancing for the one or more work requests by processing the one or more work requests in order of priority assigned to the at least one of the at least one application program 1047.

The API 1045 may be, for example, an interface in which the application program 1047 controls a function provided from the kernel 1041 or the middleware 1043. For example, the API 1045 may include at least one interface or function (e.g., a command) for file control, window control, image processing, or text control, and the like.

The I/O interface 1050 may play a role as, for example, an interface which may send a command or data, input from a user or another external device, to another component (or other components) of the electronic device 1001. Also, the I/O interface 1050 may output a command or data, received from another component (or other components) of the electronic device 1001, to the user or the other external device.

The display 1060 may include, for example, a liquid crystal display (LCD), a light emitting diode (LED) display, an organic LED (OLED) display, a microelectromechanical systems (MEMS) display, or an electronic paper display. The display 1060 may display, for example, a variety of content (e.g., text, images, videos, icons, or symbols, and the like) to the user. The display 1060 may include a touch screen, and may receive, for example, a touch, a gesture, proximity, or a hovering input using an electronic pen or part of a body of the user.

The communication interface 1070 may establish communication between, for example, the electronic device 1001 and an external device (e.g., a first external electronic device 1002, a second external electronic device 1004, or a server 1006). For example, the communication interface 1070 may connect to the network 1062 through wireless communication or wired communication and may communicate with the external device (e.g., the second external electronic device 1004 or the server 1006).

The wireless communication may use, for example, at least one of long term evolution (LTE), LTE-advanced (LTE-A), code division multiple access (CDMA), wideband CDMA (WCDMA), universal mobile telecommunications system (UMTS), wireless broadband (WiBro), or global system for mobile communications (GSM), and the like as a cellular communication protocol. Also, the wireless communication may include, for example, the local-area communication 1064. The local-area communication 1064 may include, for example, at least one of WI-FI® communication, BLUETOOTH® (BT) communication, near field communication (NFC) communication, magnetic stripe transmission (MST) communication, or global navigation satellite system (GNSS) communication, and the like.

An MST module may generate a pulse based on transmission data using an electromagnetic signal and may generate a magnetic field signal based on the pulse. The electronic device 1001 may send the magnetic field signal to a point of sales (POS) system. The POS system may restore the data by detecting the magnetic field signal using an MST reader and converting the detected magnetic field signal into an electric signal.

The GNSS may include, for example, at least one of a global positioning system (GPS), a GLONASS, a BEIDOU navigation satellite system (hereinafter referred to as “BEIDOU”), or a GALILEO (i.e., the European global satellite-based navigation system) according to an available area or a bandwidth, and the like. Hereinafter, the “GPS” used herein may be interchangeably with the “GNSS”. The wired communication may include at least one of, for example, universal serial bus (USB) communication, high definition multimedia interface (HDMI) communication, recommended standard 232 (RS-232) communication, or plain old telephone service (POTS) communication, and the like. The network 1062 may include a telecommunications network, for example, at least one of a computer network (e.g., a local area network (LAN) or a wide area network (WAN)), the Internet, or a telephone network.

Each of the first and second external electronic devices 1002 and 1004 may be the same as or different device from the electronic device 1001. According to an embodiment, the server 1006 may include a group of one or more servers. According to various embodiments, all or some of operations executed in the electronic device 1001 may be executed in another electronic device or a plurality of electronic devices (e.g., the first external electronic device 1002, the second external electronic device 1004, or the server 1006). According to an embodiment, if the electronic device 1001 should perform any function or service automatically or according to a request, it may request another device (e.g., the first external electronic device 1002, the second external electronic device 1004, or the server 1006) to perform at least part of the function or service, rather than executing the function or service for itself or in addition to the function or service. The other electronic device (e.g., the first external electronic device 1002, the second external electronic device 1004, or the server 1006) may execute the requested function or the added function and may transmit the executed result to the electronic device 1001. The electronic device 1001 may process the received result without change or additionally and may provide the requested function or service. For this purpose, for example, cloud computing technologies, distributed computing technologies, or client-server computing technologies may be used.

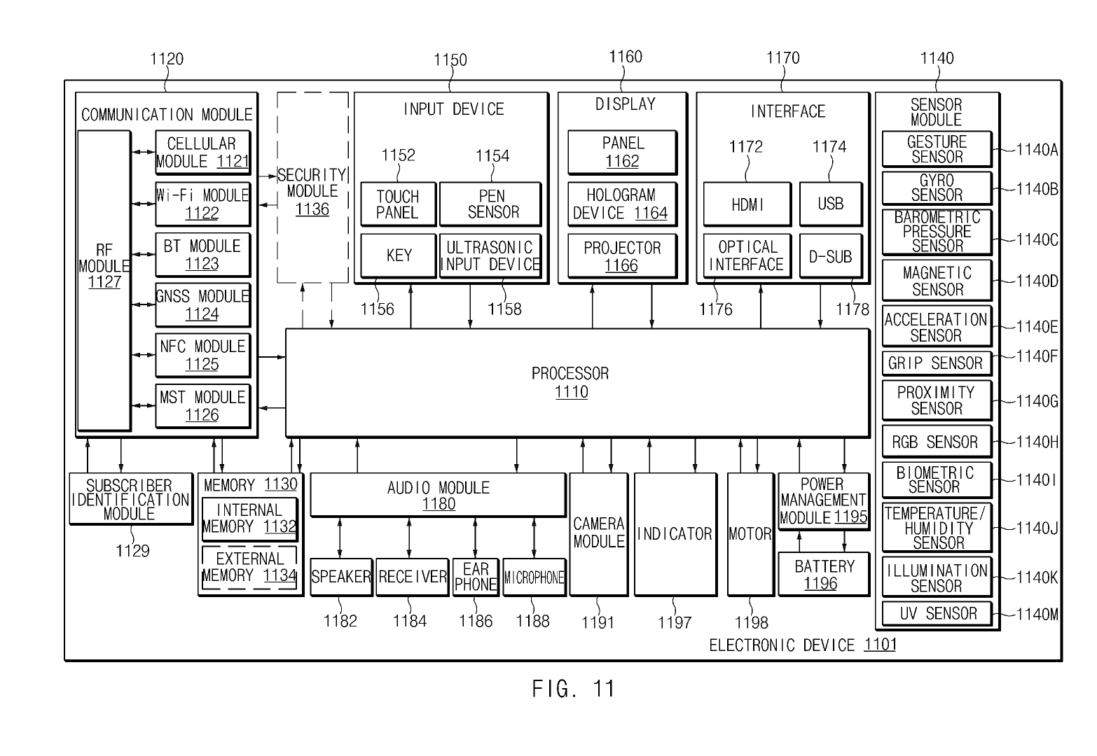

FIG. 11 illustrates a configuration of an electronic device 1101 according to various embodiments.

Referring to FIG. 11, the electronic device 1101 may include, for example, all or part of an electronic device 1001 shown in FIG. 10. The electronic device 1101 may include one or more processors 1110 (e.g., application processors (APs)), a communication module 1120, a subscriber identification module (SIM) 1129, a memory 1130, a secure module 1136, a sensor module 1140, an input device 1150, a display 1160, an interface 1170, an audio module 1180, a camera module 1191, a power management module 1195, a battery 1196, an indicator 1197, and a motor 1198.

The processor 1110 may execute, for example, an operating system (OS) or an application program to control a plurality of hardware or software components connected thereto and may process and compute a variety of data. The processor 1110 may be implemented with, for example, a system on chip (SoC). According to an embodiment, the processor 1110 may include a graphic processing unit (GPU) (not shown) and/or an image signal processor (not shown). The processor 1110 may include at least some (e.g., a cellular module 1121) of the components shown in FIG. 11. The processor 1110 may load a command or data, received from at least one of other components (e.g., a non-volatile memory), to a volatile memory to process the data and may store various data in a non-volatile memory.

The communication module 1120 may have the same or similar configuration to a communication interface 1070 of FIG. 10. The communication module 1120 may include, for example, the cellular module 1121, a WI-FI® module 1122, a BLUETOOTH® (BT) module 1123, a global navigation satellite system (GNSS) module 1124 (e.g., a GPS module, a GLONASS module, a BEIDOU module, or a GALILEO module), a near field communication (NFC) module 1125, an MST module 1126, and a radio frequency (RF) module 1127.

The cellular module 1121 may provide, for example, a voice call service, a video call service, a text message service, or an Internet service, and the like over a communication network. According to an embodiment, the cellular module 1121 may identify and authenticate the electronic device 1101 in a communication network using the SIM 1129 (e.g., a SIM card). According to an embodiment, the cellular module 1121 may perform at least some of functions which may be provided by the processor 1110. According to an embodiment, the cellular module 1121 may include a communication processor (CP).

The WI-FI® module 1122, the BT module 1123, the GNSS module 1124, the NFC module 1125, or the MST module 1126 may include, for example, a processor for processing data communicated through the corresponding module. According to various embodiments, at least some (e.g., two or more) of the cellular module 1121, the WI-FI® module 1122, the BT module 1123, the GNSS module 1124, the NFC module 1125, or the MST module 1126 may be included in one integrated chip (IC) or one IC package.

The RF module 1127 may communicate, for example, a communication signal (e.g., an RF signal). Though not shown, the RF module 1127 may include, for example, a transceiver, a power amplifier module (PAM), a frequency filter, or a low noise amplifier (LNA), or an antenna, and the like. According to another embodiment, at least one of the cellular module 1121, the Wi-Fi module 1122, the BT module 1123, the GNSS module 1124, the NFC module 1125, or the MST module 1126 may communicate an RF signal through a separate RF module.

The SIM 1129 may include, for example, a card which includes a SIM and/or an embedded SIM. The SIM 1129 may include unique identification information (e.g., an integrated circuit card identifier (ICCID)) or subscriber information (e.g., an international mobile subscriber identity (IMSI)).

The memory 1130 (e.g., a memory 1030 of FIG. 10) may include, for example, an embedded memory 1132 or an external memory 1134. The embedded memory 1132 may include at least one of, for example, a volatile memory (e.g., a dynamic random access memory (DRAM), a static RAM (SRAM), a synchronous dynamic RAM (SDRAM), and the like), or a non-volatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash memory or a NOR flash memory, and the like), a hard drive, or a solid state drive (SSD)).

The external memory 1134 may include a flash drive, for example, a compact flash (CF), a secure digital (SD), a micro-SD, a mini-SD, an extreme digital (xD), a multimedia card (MMC), or a memory stick, and the like. The external memory 1134 may operatively and/or physically connect with the electronic device 1101 through various interfaces.

The secure module 1136 may be a module which has a relatively higher secure level than the memory 1130 and may be a circuit which stores secure data and guarantees a protected execution environment. The secure module 1136 may be implemented with a separate circuit and may include a separate processor. The secure module 1136 may include, for example, an embedded secure element (eSE) which is present in a removable smart chip or a removable SD card or is embedded in a fixed chip of the electronic device 1101. Also, the secure module 1136 may be driven by an OS different from the OS of the electronic device 1101. For example, the secure module 1136 may operate based on a java card open platform (JCOP) OS.

The sensor module 1140 may measure, for example, a physical quantity or may detect an operation state of the electronic device 1101, and may convert the measured or detected information to an electric signal. The sensor module 1140 may include at least one of, for example, a gesture sensor 1140A, a gyro sensor 1140B, a barometric pressure sensor 1140C, a magnetic sensor 1140D, an acceleration sensor 1140E, a grip sensor 1140F, a proximity sensor 1140G, a color sensor 1140H (e.g., red, green, blue (RGB) sensor), a biometric sensor 11401, a temperature/humidity sensor 1140J, an illumination sensor 1140K, or an ultraviolet (UV) sensor 1140M. Additionally or alternatively, the sensor module 1140 may further include, for example, an e-nose sensor (not shown), an electromyography (EMG) sensor (not shown), an electroencephalogram (EEG) sensor (not shown), an electrocardiogram (ECG) sensor (not shown), an infrared (IR) sensor (not shown), an iris sensor (not shown), and/or a fingerprint sensor (not shown), and the like. The sensor module 1140 may further include a control circuit for controlling at least one or more sensors included therein. In various embodiments, the electronic device 1101 may further include a processor configured to control the sensor module 1140, as part of the processor 1110 or to be independent of the processor 1110. While the processor 1110 is in a sleep state, the electronic device 1101 may control the sensor module 1140.

The input device 1150 may include, for example, a touch panel 1152, a (digital) pen sensor 1154, a key 1156, or an ultrasonic input unit 1158. The touch panel 1152 may use, for example, at least one of a capacitive type, a resistive type, an infrared type, or an ultrasonic type. Also, the touch panel 1152 may include a control circuit. The touch panel 1152 may further include a tactile layer and may provide a tactile reaction to a user.

The (digital) pen sensor 1154 may be, for example, part of the touch panel 1152 or may include a separate sheet for recognition. The key 1156 may include, for example, a physical button, an optical key, or a keypad. The ultrasonic input unit 1158 may allow the electronic device 1101 to detect an ultrasonic wave generated by an input tool, through a microphone (e.g., a microphone 1188) and to verify data corresponding to the detected ultrasonic wave.

The display 1160 (e.g., a display 1060 of FIG. 10) may include a panel 1162, a hologram device 1164, or a projector 1166. The panel 1162 may include the same or similar configuration to the display 1060. The panel 1162 may be implemented to be, for example, flexible, transparent, or wearable. The panel 1162 and the touch panel 1152 may be integrated into one module. The hologram device 1164 may show a stereoscopic image in a space using interference of light. The projector 1166 may project light onto a screen to display an image. The screen may be positioned, for example, inside or outside the electronic device 1101. According to an embodiment, the display 1160 may further include a control circuit for controlling the panel 1162, the hologram device 1164, or the projector 1166.

The interface 1170 may include, for example, a high-definition multimedia interface (HDMI) 1172, a universal serial bus (USB) 1174, an optical interface 1176, or a D-subminiature 1178. The interface 1170 may be included in, for example, a communication interface 1070 shown in FIG. 10. Additionally or alternatively, the interface 1170 may include, for example, a mobile high definition link (MHL) interface, an SD card/multimedia card (MMC) interface, or an infrared data association (IrDA) standard interface.

The audio module 1180 may interchangeably convert a sound into an electric signal. At least some of components of the audio module 1180 may be included in, for example, an input and output interface 1050 shown in FIG. 10. The audio module 1180 may process sound information input or output through, for example, a speaker 1182, a receiver 1184, an earphone 1186, or the microphone 1188, and the like.

The camera module 1191 may be a device which captures a still image and a moving image. According to an embodiment, the camera module 1191 may include one or more image sensors (not shown) (e.g., a front sensor or a rear sensor), a lens (not shown), an image signal processor (ISP) (not shown), or a flash (not shown) (e.g., an LED or a xenon lamp).

The power management module 1195 may manage, for example, power of the electronic device 1101. According to an embodiment, though not shown, the power management module 1195 may include a power management integrated circuit (PMIC), a charger IC or a battery or fuel gauge. The PMIC may have a wired charging method and/or a wireless charging method. The wireless charging method may include, for example, a magnetic resonance method, a magnetic induction method, or an electromagnetic method, and the like. An additional circuit for wireless charging, for example, a coil loop, a resonance circuit, or a rectifier, and the like may be further provided. The battery gauge may measure, for example, the remaining capacity of the battery 1196 and voltage, current, or temperature thereof while the battery 1196 is charged. The battery 1196 may include, for example, a rechargeable battery or a solar battery.

The indicator 1197 may display a specific state of the electronic device 1101 or part (e.g., the processor 1110) thereof, for example, a booting state, a message state, or a charging state, and the like. The motor 1198 may convert an electric signal into mechanical vibration and may generate vibration or a haptic effect, and the like. Though not shown, the electronic device 1101 may include a processing unit (e.g., a GPU) for supporting a mobile TV. The processing unit for supporting the mobile TV may process media data according to standards, for example, a digital multimedia broadcasting (DMB) standard, a digital video broadcasting (DVB) standard, or a MEDIAFLO™ standard, and the like.

Each of the above-mentioned elements of the electronic device according to various embodiments of the present disclosure may be configured with one or more components, and names of the corresponding elements may be changed according to the type of the electronic device. The electronic device according to various embodiments of the present disclosure may include at least one of the above-mentioned elements, some elements may be omitted from the electronic device, or other additional elements may be further included in the electronic device. Also, some of the elements of the electronic device according to various embodiments of the present disclosure may be combined with each other to form one entity, thereby making it possible to perform the functions of the corresponding elements in the same manner as before the combination.

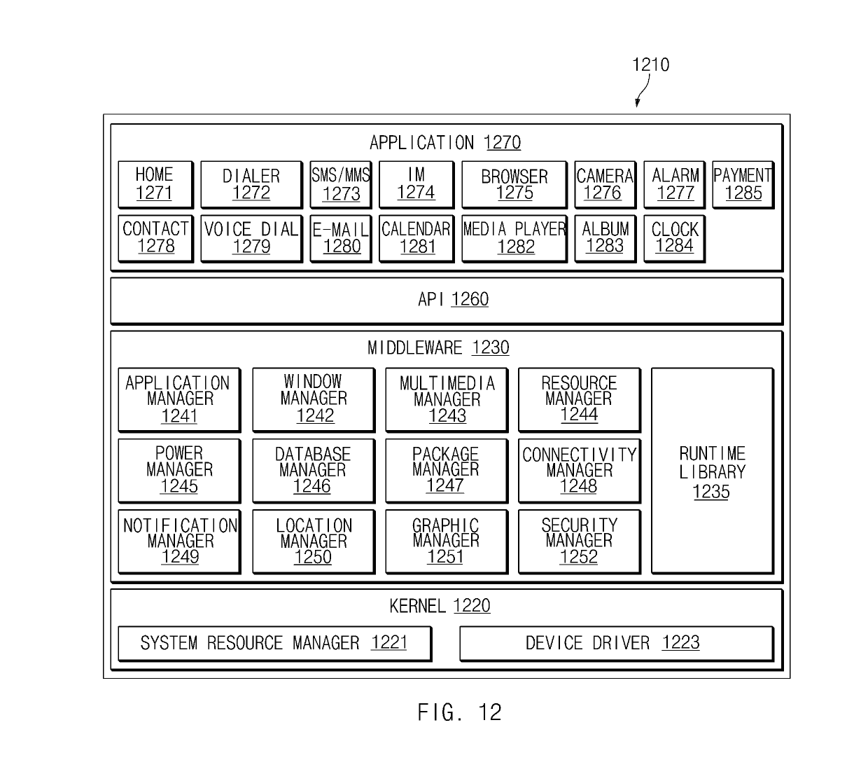

FIG. 12 illustrates a configuration of a program module according to various embodiments.

Referring to FIG. 12, according to an embodiment, a program module 1210 (e.g., a program 1040 of FIG. 10) may include an operating system (OS) for controlling resources associated with an electronic device (e.g., an electronic device 1001 of FIG. 10) and/or various applications (e.g., at least one application program 1047 of FIG. 10) which are executed on the OS. The OS may be, for example, ANDROID®, iOS®, WINDOWS®, SYMBIAN OS™, TIZEN®, or SAMSUNG BADA®, and the like.

The program module 1210 may include a kernel 1220, a middleware 1230, an application programming interface (API) 1260, and/or at least one application 1270. At least part of the program module 1210 may be preloaded on the electronic device, or may be downloaded from an external electronic device (e.g., a first external electronic device 1002, a second external electronic device 1004, or a server 1006, and the like of FIG. 10).

The kernel 1220 (e.g., a kernel 1041 of FIG. 10) may include, for example, a system resource manager 1221 and/or a device driver 1223. The system resource manager 1221 may control, assign, or collect, and the like system resources. According to an embodiment, the system resource manager 1221 may include a process management unit, a memory management unit, or a file system management unit, and the like. The device driver 1223 may include, for example, a display driver, a camera driver, a Bluetooth (BT) driver, a shared memory driver, a universal serial bus (USB) driver, a keypad driver, a wireless-fidelity (Wi-Fi) driver, an audio driver, or an inter-process communication (IPC) driver.

The middleware 1230 (e.g., a middleware 1043 of FIG. 10) may provide, for example, functions the application 1270 needs in common, and may provide various functions to the application 1270 through the API 1260 such that the application 1270 efficiently uses limited system resources in the electronic device. According to an embodiment, the middleware 1230 (e.g., the middleware 1043) may include at least one of a runtime library 1235, an application manager 1241, a window manager 1242, a multimedia manager 1243, a resource manager 1244, a power manager 1245, a database manager 1246, a package manager 1247, a connectivity manager 1248, a notification manager 1249, a location manager 1250, a graphic manager 1251, a security manager 1252, or a payment manager.

The runtime library 1235 may include, for example, a library module used by a compiler to add a new function through a programming language while the application 1270 is executed. The runtime library 1235 may perform a function about input and output management, memory management, or an arithmetic function.

The application manager 1241 may manage, for example, a life cycle of at least one of the at least one application 1270. The window manager 1242 may manage graphic user interface (GUI) resources used on a screen of the electronic device. The multimedia manager 1243 may ascertain a format necessary for reproducing various media files and may encode or decode a media file using a codec corresponding to the corresponding format. The resource manager 1244 may manage source codes of at least one of the at least one application 1270, and may manage resources of a memory or a storage space, and the like.

The power manager 1245 may act together with, for example, a basic input/output system (BIOS) and the like, may manage a battery or a power source, and may provide power information necessary for an operation of the electronic device. The database manager 1246 may generate, search, or change a database to be used in at least one of the at least one application 1270. The package manager 1247 may manage installation or update of an application distributed by a type of a package file.

The connectivity manager 1248 may manage, for example, wireless connection such as Wi-Fi connection or BT connection, and the like. The notification manager 1249 may display or notify events, such as an arrival message, an appointment, and proximity notification, by a method which is not disturbed to the user. The location manager 1250 may manage location information of the electronic device. The graphic manager 1251 may manage a graphic effect to be provided to the user or a user interface (UI) related to the graphic effect. The security manager 1252 may provide all security functions necessary for system security or user authentication, and the like. According to an embodiment, when the electronic device (e.g., the electronic device 1001) has a phone function, the middleware 1230 may further include a telephony manager (not shown) for managing a voice or video communication function of the electronic device.

The middleware 1230 may include a middleware module which configures combinations of various functions of the above-described components. The middleware 1230 may provide a module which specializes according to kinds of OSs to provide a differentiated function. Also, the middleware 1230 may dynamically delete some of old components or may add new components.

The API 1260 (e.g., an API 1045 of FIG. 10) may be, for example, a set of API programming functions, and may be provided with different components according to OSs. For example, in case of Android or iOS, one API set may be provided according to platforms. In case of TIZEN®, two or more API sets may be provided according to platforms.

The application 1270 (e.g., an application program 1047 of FIG. 10) may include one or more of, for example, a home application 1271, a dialer application 1272, a short message service/multimedia message service (SMS/MMS) application 1273, an instant message (IM) application 1274, a browser application 1275, a camera application 1276, an alarm application 1277, a contact application 1278, a voice dial application 1279, an e-mail application 1280, a calendar application 1281, a media player application 1282, an album application 1283, a clock application 1284, a payment application 1285, a health care application (e.g., an application for measuring quantity of exercise or blood sugar, and the like), or an environment information application (e.g., an application for providing atmospheric pressure information, humidity information, or temperature information, and the like), and the like.

According to an embodiment, the application 1270 may include an application (hereinafter, for better understanding and ease of description, referred to as “information exchange application”) for exchanging information between the electronic device (e.g., the electronic device 1001) and an external electronic device (e.g., the first external electronic device 1002 or the second external electronic device 1004). The information exchange application may include, for example, a notification relay application for transmitting specific information to the external electronic device or a device management application for managing the external electronic device.

For example, the notification relay application may include a function of transmitting notification information, which is generated by other applications (e.g., the SMS/MMS application, the e-mail application, the health care application, or the environment information application, and the like) of the electronic device, to the external electronic device (e.g., the first external electronic device 1002 or the second external electronic device 1004). Also, the notification relay application may receive, for example, notification information from the external electronic device, and may provide the received notification information to the user of the electronic device.

The device management application may manage (e.g., install, delete, or update), for example, at least one (e.g., a function of turning on/off the external electronic device itself (or partial components) or a function of adjusting brightness (or resolution) of a display) of functions of the external electronic device (e.g., the first external electronic device 1002 or the second external electronic device 1004) which communicates with the electronic device, an application which operates in the external electronic device, or a service (e.g., a call service or a message service) provided from the external electronic device.

According to an embodiment, the application 1270 may include an application (e.g., the health card application of a mobile medical device) which is preset according to attributes of the external electronic device (e.g., the first external electronic device 1002 or the second external electronic device 1004). According to an embodiment of the present disclosure, the application 1270 may include an application received from the external electronic device (e.g., the server 1006, the first external electronic device 1002, or the second external electronic device 1004). According to an embodiment of the present disclosure, the application 1270 may include a preloaded application or a third party application which may be downloaded from a server. Names of the components of the program module 1210 according to various embodiments of the present disclosure may differ according to kinds of OSs.

According to various embodiments, at least part of the program module 1210 may be implemented with software, firmware, hardware, or at least two or more combinations thereof. At least part of the program module 1210 may be implemented (e.g., executed) by, for example, a processor (e.g., a processor 1110 of FIG. 11). At least part of the program module 1210 may include, for example, a module, a program, a routine, sets of instructions, or a process, and the like for performing one or more functions.

The terminology “module” used herein may mean, for example, a unit including one of hardware, software, and firmware or two or more combinations thereof. The terminology “module” may be interchangeably used with, for example, terminologies “unit”, “logic”, “logical block”, “component”, or “circuit”, and the like. The “module” may be a minimum unit of an integrated component or a part thereof. The “module” may be a minimum unit performing one or more functions or a part thereof. The “module” may be mechanically or electronically implemented. For example, the “module” may include at least one of an application-specific integrated circuit (ASIC) chip, field-programmable gate arrays (FPGAs), or a programmable-logic device, which is well known or will be developed in the future, for performing certain operations.

According to various embodiments, at least part of a device (e.g., modules or the functions) or a method (e.g., operations) may be implemented with, for example, instructions stored in computer-readable storage media which have a program module. When the instructions are executed by a processor (e.g., a processor 1020 of FIG. 10), one or more processors may perform functions corresponding to the instructions. The computer-readable storage media may be, for example, a memory 1030 of FIG. 10. According to an embodiment, the computer-readable storage media which stores instructions, when executed by at least one processor, the instructions configured to include activating a camera module of an electronic device if a plurality of touch inputs on designated locations of a display of the electronic device are obtained, obtaining an additional input corresponding to a changed input after one of the plurality of touch input is changed, and executing a function mapped with an input pattern of the additional input based on the input pattern of the additional input.

The computer-readable storage media may include a hard disc, a floppy disk, magnetic media (e.g., a magnetic tape), optical media (e.g., a compact disc read only memory (CD-ROM) and a digital versatile disc (DVD)), magneto-optical media (e.g., a floptical disk), a hardware device (e.g., a ROM, a random access memory (RAM), or a flash memory, and the like), and the like. Also, the program instructions may include not only mechanical codes compiled by a compiler but also high-level language codes which may be executed by a computer using an interpreter and the like. The above-mentioned hardware device may be configured to operate as one or more software modules to perform operations according to various embodiments of the present disclosure, and vice versa.

Modules or program modules according to various embodiments may include at least one or more of the above-mentioned components, some of the above-mentioned components may be omitted, or other additional components may be further included. Operations executed by modules, program modules, or other components may be executed by a successive method, a parallel method, a repeated method, or a heuristic method. Also, some operations may be executed in a different order or may be omitted, and other operations may be added.

According to various embodiments, the electronic device may provide a user interface which may use the entire region of a curved display by executing various functions based on a change of one of a plurality of touch inputs for activating the camera module.

According to various embodiments, the electronic device may efficiently use a front region and a rear region of the curved display by selectively activating the front region or the rear region of the curved display based on a location of a touch input.

In addition, according to various embodiments, the electronic device may provide various effects directly or indirectly determined through the present disclosure.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An electronic device, comprising:
a display configured to include a front region, a side region connected with an edge of the front region, and a rear region connected with an edge of the side region;
a touch sensor configured to sense a touch input on the front region, the side region, or the rear region;
a camera module configured to generate an image for an object to be captured; and
a processor configured to electrically connect with the display, the touch sensor, and the camera module,
wherein the processor is configured to:
activate the camera module, if a plurality of touch inputs on designated locations are obtained by the touch sensor;
detect an additional input, after at least one of the plurality of touch inputs is changed; and
execute a function mapped with an input pattern of the additional input.

2. The electronic device of claim 1, wherein the processor is configured to execute the function based on at least one of a start point, an end point, an area, or duration of the additional input.

3. The electronic device of claim 1, wherein the processor is configured to capture a photo or video using the camera module when the additional input is a tap input on the side region.

4. The electronic device of claim 1, wherein the processor is configured to adjust a sensitivity of the camera module when the additional input is a drag input in a designated direction on the side region.

5. The electronic device of claim 1, wherein the processor is configured to adjust a zoom magnification of the camera module when the additional input is a drag input in a designated direction on the side region.

6. The electronic device of claim 1, wherein the processor is configured to simultaneously output a preview image obtained by the camera module on the front region and the rear region when the additional input is a flicking input in a designated direction on the side region.

7. The electronic device of claim 1, wherein the camera module comprises a front camera and a rear camera, and
wherein the processor is configured to:
activate the rear camera when detecting a flicking input in a first direction on the side region as the additional input in a state where the front camera is activated; and
activate the front camera when detecting a flicking input in a second direction on the side region as the additional input in a state where the rear camera is activated.

8. The electronic device of claim 1, wherein the camera module comprises a front camera and a rear camera, and
wherein the processor is configured to selectively activate one of the front camera or the rear camera based on input locations of the plurality of touch inputs.

9. The electronic device of claim 1, wherein the processor is configured to selectively activate one of the front region or the rear region based on input locations of the plurality of touch inputs.

10. The electronic device of claim 1, wherein the processor is configured to:
recognize a face of the object to be captured, from a preview image obtained by the camera module; and
provide content based on a prestored information about the object to be captured.

11. The electronic device of claim 1, wherein the processor is configured to output a photo or video throughout all of the front region, the side region, and the rear region when a photo or video is captured by the camera module.

12. The electronic device of claim 1, wherein the processor is configured to determine a display location of a user interface displayed on the display based on input locations of the plurality of touch inputs.

13. The electronic device of claim 1, further comprising:
a gravity sensor,
wherein the processor is configured to:
determine locations of a top surface and a bottom surface of the electronic device based on information sensed by the gravity sensor; and
execute a function based on the locations of the top surface and the bottom surface of the electronic device.

14. The electronic device of claim 1, wherein the processor is configured to:
determine a posture of the electronic device based on locations of the plurality of touch in puts; and
execute a function based on the posture of the electronic device.

15. A camera control method of an electronic device, the method comprising:
activating a camera module of the electronic device when a plurality of touch inputs on designated locations of a display of the electronic device are obtained;
detecting an additional input after at least one of the plurality of touch inputs is changed; and
executing a function mapped with an input pattern of the additional input based on the input pattern of the additional input.

16. The method of claim 15, wherein the executing of the function comprises:
simultaneously outputting a preview image obtained by the camera module on a front region and a rear region of the display when the additional input is a flicking input in a designated direction on a side region of the display.

17. The method of claim 15, wherein the executing of the function comprises:
activating a rear camera included in the camera module when a flicking input in a first direction on a side region of the display is detected as the additional input in a state where a front camera included in the camera module is activated; and
activating a front camera included in the camera module when a flicking input in a second direction on the side region of the display is detected as the additional input in a state where the rear camera is activated.

18. The method of claim 15, wherein the activating of the camera module comprises:
selectively activating one of a front camera or a rear camera included in the camera module based on input locations of the plurality of touch inputs.

19. The method of claim 15, further comprising:
outputting a photo or video throughout all of a front region, a side region, and a rear region of the display when the photo or video is captured by the camera module.

20. A computer-readable recording medium storing instructions thereon that when executed by at least one processor cause the processor to perform:
activating a camera module of an electronic device when a plurality of touch inputs on designated locations of a display of the electronic device are obtained;
detecting an additional input after at least one of the plurality of touch inputs is changed; and
executing a function mapped with an input pattern of the additional input based on the input pattern of the additional input.
